(19) United States
(12) Patent Application Publication
(10) Pub. No.: US 2025/0263197 A1
(43) Pub. Date: Aug. 21, 2025

(54) CONTAINER SUITABLE FOR HOLDING PORTIONED FOOD AND METHOD FOR ASSEMBLY OF SUCH A CONTAINER AND METHOD FOR DISASSEMBLY OF SUCH A CONTAINER

(71) Applicant: PACCOR PACKAGING GMBH, Dûsseldorf (DE)

(72) Inventors: Yves Caunegre, Soustons (FR); Michael Corsi, Magescq (FR)

(21) Appl. No.: 18/702,560

(22) PCT Filed: Oct. 19, 2022
(86) PCT No.: PCT/EP2022/079064

§ 371 Date: Apr. 18, 2024

(30) Foreign Application Priority Data
Oct. 20, 2021 (EP) 21290067.4

(51) Int. Cl. B65D 8/00; B31B 50/59; B31B 50/81; B31B 120/10; B31B 120/40; B65D 25/14; B65D 43/02

(52) U.S. Cl. CPC B65D 15/22; B31B 50/59; B31B 50/81; B65D 25/14; B65D 43/0204; B31B 2120/10; B31B 2120/40

(57) ABSTRACT

A container suitable for holding portioned food has an outer part and an inner part. The outer part is made from a material that contains cardboard and/or paper and is tray-shaped or cup-shaped, the outer part having a bottom and either a circumferential sidewall, if the outer part is cup-shaped, or has several sidewalls that rise from the bottom, if the outer part is tray-shaped. The inner part is made from a plastic material and is tray-shaped or cup-shaped. The inner part is arranged inside the outer part and has a rim that protrudes over the outer part. The inner part has at least one protruding nose arranged distanced from the rim, and the outer part has a window, wherein the nose protrudes from the inside of the outer part through the window.

### CROSS-REFERENCE TO RELATED APPLICATIONS

This application is the National Stage Entry pursuant to 35 U.S.C. § 371 of International Patent Application No. PCT/EP2022/079064 filed on Oct. 19, 2022, which claims priority to European Patent Application No. 21 290 067.4 filed on Oct. 20, 2021, the subject matter of which is incorporated by reference herein in its entirety.

### FIELD OF THE INVENTION

The invention pertains to a container suitable for holding portioned food. The invention also pertains to a method for assembly for such a container. The invention also pertains to a method for disassembly of such a container.

### BACKGROUND

Containers that are suitable for holding portioned food are known in many different shapes and designs. A specific subgroup of these containers works with an outer part that is made from a material that contains cardboard and/or paper and an inner part that is made from plastic material. This general design of a container is typically used in situations, where the inner part that is made from plastic material is adapted to conform with specific hygienic and tightness against leakage requirements and the outer part that is made from a material that contains cardboard and/or paper is adapted to give the container additional strength or rigidity and/or communication possibility. This general design provides the possibility to reduce the amount of plastic used, as the inner part that is made from a plastic material can be made as thin as the hygienic and/or tightness requirements allow, while the rigidity of the container is enhanced by the use of the outer part that is made from a material that contains cardboard and/or paper. As regards recycling, this general design of a container provides advantages, because it allows the customer to disassemble the container and place the outer part that is made from a material that contains cardboard and/or paper into facilities for cardboard/paper recycling, while the customer can place the inner part that is made from a plastic material into facilities for recycling plastic.

In the containers of this general design that are known from everyday life, the inner part is glued to the outer part. This design has proven to give rise to problems. The presence of the glue makes it difficult, to easily disassemble the outer part and the inner part. Sometimes sections of the outer part remain glued to the inner part. Sometimes during the disassembly, the outer part tears away parts of the inner part. Furthermore, the glue needs to be especially adapted so as to not deteriorate the properties of the inner part that is made from plastic material. Lastly, during assembly of such a container, the application of glue is an additional production step that costs time and money.

Given this background, the problem to be solved by the invention is to provide a container suitable for holding portioned food that can be easily produced and/or easily disassembled.

This problem is solved by the container, the method for assembly of a container, and the method for disassembly of a container disclosed in the description that follows hereafter. Preferred embodiments are disclosed in the description that follows hereafter.

### SUMMARY OF THE INVENTION

The invention is based on the basic concept to provide the inner part with at least one protruding nose, whereby the nose is arranged distanced from the rim and to provide the outer part with a window, whereby the nose protrudes from the inside of the outer part through the window. It was found that the interaction between the nose and the window can provide a sufficient withholding force to hold the inner part in the outer part for all typical handling conditions of such a container. If the nose and the window are provided as suggested by the invention, there is no necessity to glue the outer part to the inner part. Hence, in a preferred embodiment, the inner part is not glued to the outer part. At the same time, the interaction of the nose with the window to hold the inner part in the outer part is sufficiently easily released such that the general advantages of such type of containers, especially as regards the separation of the inner part and the outer part for separate ways of recycling, can still be kept.

The container according to the invention comprises an outer part and an inner part. Designs are feasible, where the container contains further parts. For example, a further part may be arranged between the outer part and the inner part, for example to provide insulation. Also, a further part may be provided outside of the outer part. However, in a more preferred embodiment, the container according to the invention consists of the outer part and the inner part. In an alternative, the container according to the invention consists of an outer part and an inner part and a lid that is connected to the rim of the inner part. In an alternative, the container according to the invention consists of an outer part and an inner part and a foil attached to the rim of the inner part. In an alternative, the container consists of an outer part and an inner part and a foil attached to the rim of the inner part and a lid attached to the rim of the inner part.

According to the invention, the outer part is made from a material that contains cardboard and/or paper. The paper and/or cardboard can be virgin or recycled or partially recycled. The paper and/or cardboard can be coated or non coated. The paper and/or cardboard can have a grammage between 150 to 300 gr/m2, preveragly of 200 and 250 gr/m2. Designs are feasible, where the outer part is provided with labels attached to the outside of the outer part. Designs are also feasible, where the outer part is colored or where a pattern or a text is printed to the outside or the inside of the outer part.

In a preferred embodiment, the outer part has no plastic layer and/or is made from a plastic-free and/or a mono material.

The outer part can be tray-shaped or cup-shaped. When the outer part is cup-shaped, the outer part has the shape of a hollow cylinder or a hollow cone or a hollow truncated cone. A cup-shaped outer part has a bottom and has a circumferential sidewall that rises from the bottom. In designs, where the outer part is tray-shaped, the outer part has a bottom and has several sidewalls that rise from the bottom. Typically, between neighboring sidewalls, a corner is formed, where two neighboring sidewalls join. A tray-shaped outer part may have the shape of a trough. A tray-shaped outer part also may have the shape of a pyramid or a truncated pyramid, which includes pyramids or truncated pyramids where opposing sides are of same shape and size, but neighbouring sides may be of different size. For example in a truncated pyramid two opposing sides may be shorter than the other two opposing sides that neighbour them. A tray-shaped outer part also may have a prismatic shape.

In a preferred embodiment, where the outer part is designed tray-shaped, the sidewalls are arranged to taper towards the bottom. In a preferred embodiment, the horizontal cross-sectional area of the outer part at the bottom is smaller than at the top end of the outer part.

The container according to the invention has an inner part that is made from a plastic material. In a preferred embodiment, the plastic material is a PET material or a PP material (neutral or colored) or RPET or RPP or PLA (polylactic acid). The plastic material may consist of several layers, one of them possibly bringing a functional barrier to the inner part with a different material. In a preferred embodiment, the plastic material used for the inner part or used for a layer of a multi-layer material that is used for the inner part can contain at least 20%, preferably at least 50%, preferably at least 75% and more preferably at least 90% up to 100% of recycled plastic material.

The inner part can be tray-shaped or cup-shaped. When the inner part is cup-shaped, the inner part has the shape of a hollow cylinder or a hollow cone or a hollow truncated cone. A cup-shaped inner part has a bottom and has a circumferential sidewall that rises from the bottom. In designs, where the inner part is tray-shaped, the inner part has a bottom and has several sidewalls that rise from the bottom. Typically, between neighboring sidewalls, a corner is formed, where two neighboring sidewalls join. A tray-shaped inner part may have the shape of a trough. A tray-shaped inner part also may have the shape of a pyramid or a truncated pyramid, which includes pyramids or truncated pyramids where opposing sides are of same shape and size, but neighbouring sides may be of different size. For example in a truncated pyramid two opposing sides may be shorter than the other two opposing sides that neighbour them. A tray-shaped inner part also may have a prismatic shape.

In a preferred embodiment, where the inner part is designed tray-shaped, the sidewalls are arranged to taper towards the bottom. In a preferred embodiment, the horizontal cross-sectional area of the inner part at the bottom is smaller than at the rim.

In a preferred embodiment, the inner part is deep-drawn. The term “deep-drawn” is understood to refer to a part that is thermoformed, which is understood to refer to a production process, where a sheet material is held down on a rim of a form and a combination of air pressure and plug pushes that part of the sheet material that is over the form into the form, whereby the sheet material is deformed to take up the shape of the form and keeps the shape of the form (or depending on a certain amount of backlashing keeps a shape that is similar to the form). In a preferred embodiment, the sheet material is heated prior to and/or during the deformation with the plug.

In a preferred embodiment, the outer part is made from a blank of a material that contains cardboard and/or paper by way of bending and attaching individual parts of the blank to other parts of the blank. The attachment of individual parts of the blank to other parts of the blank can be performed by way of gluing, but could also be provided by way of stapling, stitching or riveting.

In a preferred embodiment, the outer part and the inner part have the same shape. Hence, if in an embodiment the outer part is cup-shaped, the inner part also is cup-shaped. If the outer part is tray-shaped, the inner part also is tray-shaped. In a preferred embodiment, the outer part is slightly oversized over the inner part. In a preferred embodiment, a constant gap with a constant width exists between the outward facing surfaces of the inner part and the inward facing surfaces of the outer part. The width of the gap is preferably less than 5 mm, even more preferred less than 3 mm, even more preferred less than 2 mm, even more preferred less than 1 mm. In a preferred embodiment, the outer part is not undersized in comparison to the outer part so that no press-fitting exists between the outer part and the inner part. In a preferred embodiment, the outer part is oversized in comparison to the inner part just so slightly that the outer part and the inner part can easily be separated, if it were not for the interaction of the nose with the window. In a preferred embodiment, the outer part and the inner part are designed such that once the interaction between the nose and the window has been detached, outer part and inner part can easily be separated from each other.

The inner part has a rim that protrudes over the outer part. The rim preferably has a flat top surface. The top surface of the rim preferably is arranged parallel to the bottom of the inner part. The rim preferably has a width of more than 1 mm, preferably of more than 2 mm, preferably of more than 3 mm. The rim preferably has a width of less than 20 mm, preferably less than 15 mm, preferably less than 10 mm and preferably less than 7 mm. The rim may have a downward facing outer edge or a bead that runs around the outer edge of the rim. The rim preferably is a circumferential rim and runs all around the upper end of the inner part, whereby the upper end is understood to mean that part of the inner part that is arranged at the opposite end of the inner part compared to the bottom. Where the inner part is cup-shaped, the rim preferably has the shape of a circular ring, whereby it is feasible that one or more tabs protrude outward from the rim. Where the inner part is designed tray-shaped, the rim preferably follows the shape of the sidewalls of the inner part and may have the shape of a rectangular ring, a quadratic ring, a triangular ring, depending on the number of sidewalls and depending on the respective length of the sidewall. The rim may have rounded corners or may have sharp corners.

The rim protrudes over the outer part. In a preferred embodiment, the upper edge of the outer part, which is understood to mean the edge in which the outer part terminates, rests against the rim from the underside of the rim. In an alternative, the upper edge of the outer part is arranged distanced from the underside of the rim, for example arranged distanced from the underside of the rim by a distance of less than 3 mm, preferably by a distance of less than 2 mm and preferably by a distance of less than 1 mm. In a preferred embodiment, the most downward part of the rim, which may for example be the most outward end of the rim, which may be designed to point downwards or which may be a bead at the outer circumference of the rim, is arranged more downward than the upper edge of the outer part. When seen from the side, the rim preferably overlaps the upper edge of the outer part hence making the upper edge of the outer part invisible when looked at in a direct side view.

According to the invention, the inner part has at least one protruding nose, whereby the nose is arranged distanced from the rim. In a preferred embodiment, the nose is, however, arranged closer to the rim than to the bottom of the inner part. In a preferred embodiment, the nose is arranged in the top part, preferably in the top third, preferably in the top quarter, preferably in the top fifth, preferably in the top sixth part of the inner part. In a preferred embodiment, the relationship between the distance from the top surface of the rim to the lowest part of the nose to the distance from top surface of the rim to the bottom is less than 0.5, preferably less than 0.4, preferably less than 0.3, preferably less than 0.2.

In a preferred embodiment, the distance from the top surface of the rim to the lowest point of the rim, which may be the most outward part of the rim, which may be designed to be downward pointing, compared to the distance from the top surface of the rim to the most upper part of the nose is larger than 1. Hence, when seen from a side view, the nose preferably is completely visible below the rim.

According to the invention, the outer part has a window, whereby the nose protrudes from the inside of the outer part through the window. A window is understood to be a hole in the outer part, whereby the hole has a complete rim of the outer part material around it. The window may be circular or elliptical in shape. The window may also be triangular or quadratic. The window may also be of polygonal shape. In a preferred embodiment, however, the window is of rectangular shape. When reference is made to the shape of the window, the reference is preferably made to the shape that the window will have in a flat part of the blank, from which the outer part in a preferred embodiment may be made of. If the window is provided in a flat sidewall, the shape of the window remains the same. However, if the window is provided in a corner, which might be the case according to a preferred embodiment, the window will take up a bent shape depending on how the corner is made out of the flat part of the blank that is used to form the corner.

In a preferred embodiment, the window has a cross-sectional area of more than 10 mm². preferably of more than 25 mm², preferably of more than 50 mm², preferably of more than 70 mm². In a preferred embodiment, the window has a cross-sectional area of less than 1000 mm², preferably of less than 800 mm², preferably of less than 600 mm², preferably of less than 500 mm², preferably of less than 400 mm², preferably of less than 300 mm². In a preferred embodiment, where the window has a rectangular shape, the two long sides of the windows preferably run parallel to the bottom and the flat top surface of the rim (if the rim has a flat top surface), while the two small sides of the rectangular window generally run in a direction from the rim towards the bottom. In a preferred embodiment, where the window is a rectangular window, the long sides of the window may have a size of above 5 mm, preferably of above 10 mm and may have a size of preferably less than 100 mm, preferably of less than 80 mm. In a preferred embodiment, the small sides of the window may have a length of above 0.5 mm, preferably of more than 1 mm and preferably of more than 2 mm.

In a preferred embodiment, a strip of the material that the outer part is made from, is provided between the upper end of the window and the upper end of the outer part. The height of this strip of material preferably is larger than 1 mm, preferably larger than 2 mm, preferably larger than 3 mm and preferably is less than 20 mm, preferably less than 15 mm and preferably less than 10 mm.

In a preferred embodiment, the inner part has more than one protruding nose. Embodiments are feasible, where the inner part has a protruding nose that protrudes from a sidewall of the inner part. In a preferred embodiment, a tray-shaped inner part has one protruding nose each that protrudes from each sidewall. Designs are also feasible, where several protruding noses protrude from each sidewall.

In a preferred embodiment, the inner part and the outer part are designed cup-shaped and several noses are arranged to protrude from the circumferential sidewall of the inner part, whereby the outer part has several windows arranged on the circumferential sidewall of the outer part, whereby each nose protrudes from the inside of the outer part through one of the several windows. In a preferred embodiment of such an embodiment, more than two noses, preferably more than three noses and less than ten noses, preferably less than seven noses, preferably less than five noses are provided.

In an alternative, the inner part and the outer part are designed tray-shaped, whereby the inner part has several noses, whereby the respective one of the several noses is arranged to protrude either from one of the sidewalls or from a corner that is formed where two neighboring sidewalls join, whereby the outer part has several windows, whereby the respective one of the several windows is in one of the sidewalls or in a corner that is formed where two neighboring sidewalls join, whereby each nose of the several noses protrudes from the inside of the outer part through one of the several windows.

In a preferred embodiment, the inner part and the outer part are designed tray-shaped, whereby the inner part has a number of n sidewalls and a number of n corners, whereby the respective corner is formed where the two neighboring sidewalls join, whereby the inner part has a number of n noses, whereby at each of the n corners one nose is arranged to protrude from said corner, whereby the outer part has a number of n sidewalls and a number of n corners, whereby the respective corner is formed where two neighboring sidewalls join, whereby the outer part has a number of n windows, whereby at each of the n corners one window is arranged, whereby each nose protrudes from the inside of the outer part through one of the windows. In a preferred embodiment, the number n is either 3 or 4 or 5 or 6 or 7 or 8.

In a preferred embodiment, the outer part has at least one venting opening arranged either in the bottom or in a part of a sidewall that is close to the bottom or in a transition zone between the bottom and a sidewall. Providing a venting opening facilitates the inner part to be pushed into the outer part, especially if the gap between the outward facing surface of the inner part and the inward facing surface of the outer part is small. As the inner part is placed into the outer part, the air trapped below the bottom of the inner part can leave the outer part via the venting opening. Also, the venting opening facilitates the disassembly of the container, namely facilitates the inner part to be pulled out of the outer part. Especially if the gap between the outward facing surface of the inner part and the inward facing surface of the outer part is small, a little vacuum might be generated, if it is attempted to pull the inner part out of the outer part. Providing the venting opening as described in the preferred embodiment, facilitates air to enter into the room below the bottom of the inner part and hence facilitates the inner part being pulled out of the outer part. In a preferred embodiment, in a tray-shaped design outer part, a venting opening is arranged in each corner.

In a preferred embodiment, the inner part has a transition zone between the bottom and a sidewall or a transition zone between the bottom and a corner that is formed where two neighboring sidewalls join, whereby a step that protrudes into the inside of the inner part is arranged at the transition zone. In a preferred embodiment, a step that protrudes into the inside of the inner part is arranged at each transition zone between the bottom and the corner. The container hence will have as many steps as it has corners. Providing the step allows for the stacking of the inner parts. Typically, the inner parts will be transported to the final assembly line as a stack of inner parts. Providing the step ensures that the inner part that is placed into the one inner part that has the step is held in such a manner that the bottoms of the two inner parts and the rims of the two inner parts are held at a distance to each other. In a preferred embodiment, the wall of the step that is pointing from the bottom towards the rim is either arranged vertically or more preferably arranged at an angle to the vertical, preferably at an angle of more than 5°, preferably at an angle of 10° or more to the vertical. The wall of the step hence will be pointing inwards into the container at a slight angle. In a preferred embodiment, the height of the step is larger than 2 mm, preferably larger than 3 mm, preferably larger than 5 mm. In a preferred embodiment, the height of the step is equal to or larger than the distance from the top facing surface of the rim to the lowest part of the nose. In a preferred embodiment, the step is provided by one diagonal wall that runs from one sidewall to a neighboring sidewall in the corner and a top, horizontal wall.

In a preferred embodiment, the nose has a first surface section that is pointing away from the rim and a second surface section that is facing the rim, whereby the first surface section joins the second surface section by way of forming a ridge of the nose. In a preferred embodiment, the second surface section is arranged at an angle to a horizontal plane that is smaller than the angle to the horizontal plane at which the first surface section is arranged at. The first surface section hence runs at a steeper angle and is orientated more vertically than the second surface section. Having the first surface section arranged more steeper allows for the first surface section to act like a wedge and facilitate the insertion of the nose into the inner part and into the window of the inner part. Having the second surface section being arranged more closely to the horizontal than the first surface section gives the second surface section a hook-like function. A more horizontal second surface section is more suitable to abut against the rim of the window and to hold the outer part from being pulled out of the inner part. The steeper the second surface section, the more the second surface section will also function like a wedge and facilitate the nose being pulled upwards out of the window and the inner part. The above shows that choosing appropriate angles of orientation relative to the horizontal plane allows to choose between which is more important, namely an easy insertion or may be even an easy disassembly (which would lead to steeper first surface section and steeper second surface section) or a preferred strong holding of the inner part within the outer part, which would lead to a flatter second surface section.

In a preferred embodiment, the angle between the second surface section and the horizontal is preferably less than 80°, preferably less than 70° and preferably less than 60°.

In a preferred embodiment, the nose has the shape of a halfmoon with the thickest part of the halfmoon being arranged in the corner and the slimmer parts of the halfmoon transgressing into the sidewall next to the corner. The halfmoon shaped nose hence will span from the one sidewall around the corner and into the neighbouring sidewall.

In a preferred embodiment, the container has a lid that is attached to the rim of the inner part. The lid may be attached by way of a form-fit connection. The lid may have a downward angled rim that has protrusions, for example beads, arranged on the inward facing surface of the downward pointing rim. These protrusions can be used to interengage with the outer edge of the rim of the inner part and hold the lid on the rim of the inner part. Designs are also feasible, where the lid is glued to the rim. In an alternative or as an addition, a foil that closes the inner part may be attached to the rim of the inner part. This foil may be a plastic foil or may be a foil that contains aluminum or a different metal, especially may have a layer of aluminum or a different metal.

In a preferred embodiment, the volume within the inner part may be equal to or larger than 10,000 mm³ (0,01 l), preferably equal to or larger than 50,000 mm³ (0,05 l), preferably equal to or larger than 100.000 mm³ (0.1 l), preferably equal to or larger than 200,000 mm³ (0,2 l). In a preferred embodiment, the inner volume of the inner part is less than 3 million mm³ (3 l) and less than 2 million mm³ (2 l) and less than 1 million mm³ (1 l).

In a preferred embodiment, the inner part is a rigid piece, whereby rigid is understood to mean that the inner part keeps its shape, when the inner part is placed on its bottom. In a preferred embodiment, the outer part is a rigid piece, whereby rigid is understood to mean that the outer part keeps its shape, when the outer part is placed on its bottom.

According to the invention, the container according to the invention is used to hold portioned food. In a preferred embodiment, the portioned food is a portion of meat or a portion of a diary product or a portion of a cooked meal, for example a soup. The portioned food could also be a liquid food, for example a coffee or a different hot drink or could be a serving of a diary product, for example milk.

According to the method for assembly of a container at least the following steps are performed:
providing the inner part, whereby the inner part is a deep-drawn (thermoformed) part,
providing the outer part, whereby the outer part is made from a blank of a material that contains cardboard and/or paper by way of bending and attaching individual parts of the blank to other parts of the blank,
Or providing a blank of a material that contains cardboard and/or paper and that by way of bending and attaching individual parts of the blank to other parts of the blank can be formed into an outer part
if the inner part and the outer part are provided, placing the inner part inside the outer part in such a manner that the nose protrudes from the inside of the outer part through the window
if the inner part and a blank is provided,
   (1) either forming the outer part by way of bending and attaching individual parts of the blank to other parts of the blank and placing the inner part inside the thus obtained outer part in such a manner that the nose protrudes from the inside of the outer part through the window,
   (2) or bending and attaching individual parts of the blank to other parts of the blank in close proximity to the inner part and hence forming the outer part around the inner part with no need to perform the additional step of placing the inner part inside the outer part, but performing the steps of or bending and attaching individual parts of the blank to other parts of the blank in such a manner that the nose protrudes from the inside of the thus obtained outer part through the window.

In a preferred embodiment according to the method for assembly, the inner part is not glued to the outer part.

Providing the inner part, whereby the inner part is deep-drawn part, may include the method step of actually producing the inner part by way of deep-drawing (thermoforming). However, the invention can already be put into practice, if the inner part is provided as is, namely if the inner part is bought from a supplier that performs the deep-drawing/thermoforming step.

Providing the outer part, whereby the outer part is made from a blank of a material that contains cardboard and/or paper by way of bending and attaching individual parts of the blank to other parts of the blank may include the method step of actually producing the outer part by way of bending and attaching individual parts of the blank to other parts of the blank. However, the invention can already be put into practice, if the outer part is provided as is, namely if the outer part is bought from a supplier that performs the producing of the outer part from a blank.

The method for disassembly of the container according to the invention either includes pulling the inner part out of the outer part and thereby pulling the nose back inside through the window or may contain the step of pulling the inner part out of the outer part, whereby the nose is made to tear a strip of material of the outer part arranged between the window and an upper edge of the outer part.

### BRIEF DESCRIPTION OF THE FIGURES

Below the invention will be described with reference to Figures that show examples of the invention only. In the Figures

FIG. 1 show a schematic perspective view onto the container according to the invention in the assembled state;

FIG. 2 shows a schematic perspective of the container according to FIG. 1 in not yet assembled state with the inner part being above the outer part;

FIG. 3 shows a schematic perspective of a detail of the container of FIG. 1 in an enlarged manner;

FIG. 4 shows a top view onto a blank that can be used to make the outer part;

FIG. 5 show a schematic perspective view onto the inner part of container according to FIG. 1;

FIG. 6 shows a schematic top view onto the inner part of container according to FIG. 1;

FIG. 7 shows a schematic sectional view along the line A-A in FIG. 6 of the inner part of the container;

FIG. 8 shows a schematic sectional view of a detail of an inner part of a first container according to the invention set into the inner part of a second container according to the invention:

FIG. 9 shows an enlarged view of the Detail F in FIG. 8;

FIG. 10 shows a schematic sectional view along the line B-B in FIG. 7 of the inner part of the container and

FIG. 11 shows a schematic perspective view of a cup-shaped container according to the invention in not yet assembled state with the inner part being above the outer part.

### DETAILED DESCRIPTION

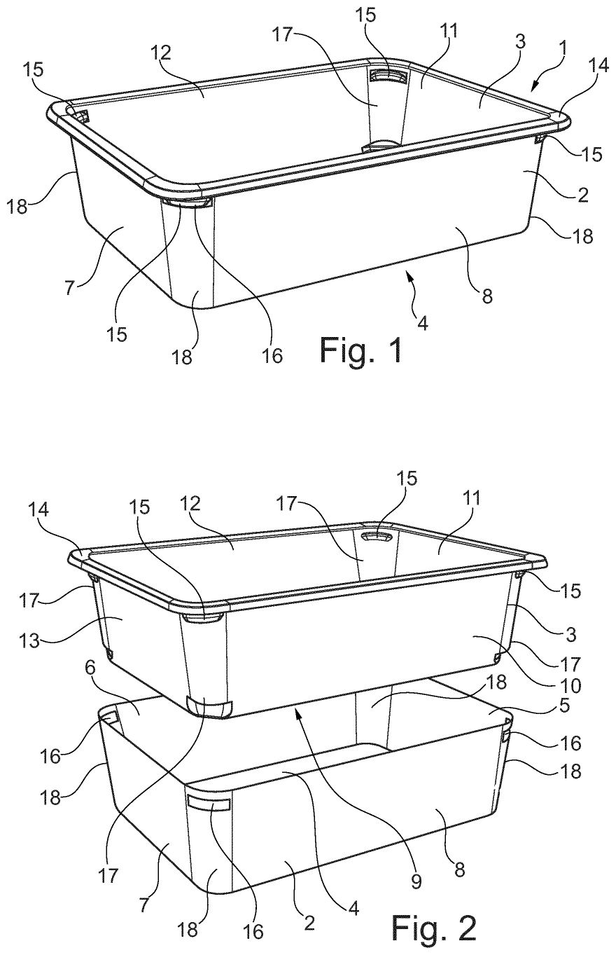

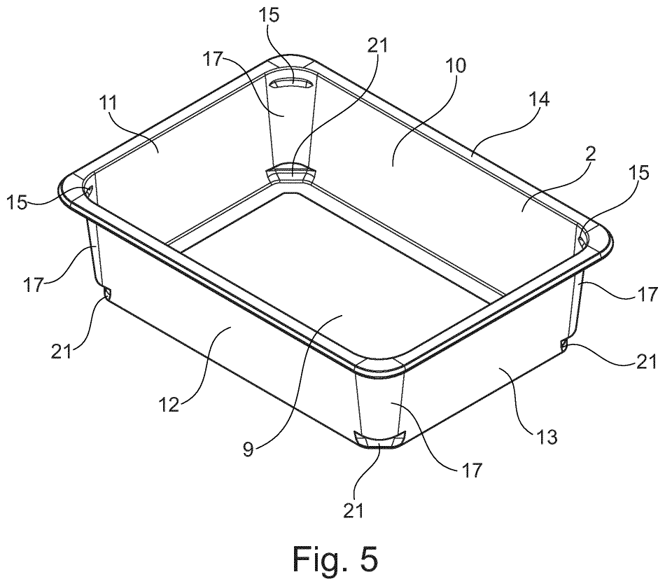

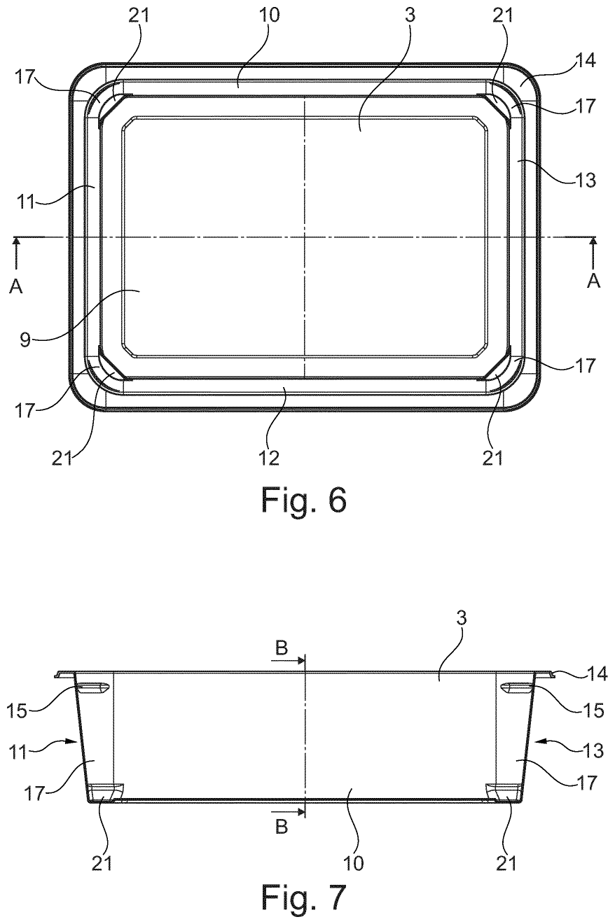

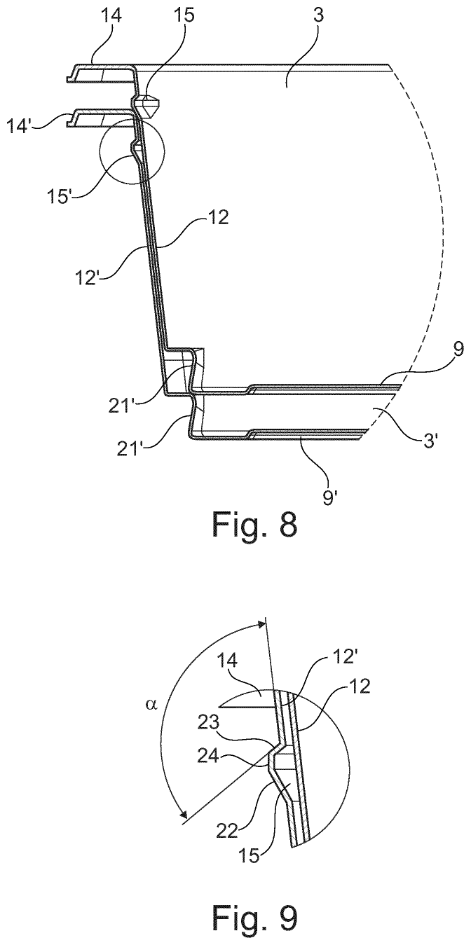

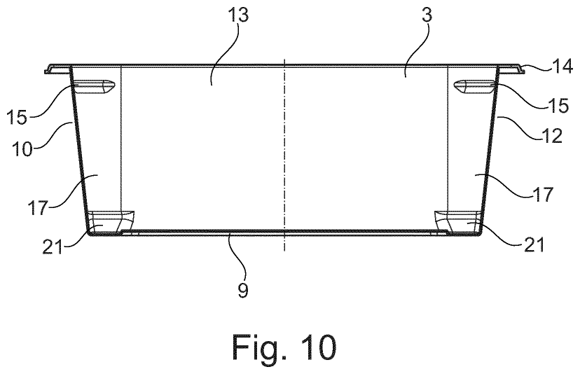

FIG. 1 shows a container 1 that is suitable for holding portioned food, for example a meat portion or a dairy product like butter or margarine. The container 1 has an outer part 2 that is made from a material that contains cardboard and/or paper. In the embodiment shown in the FIGS. 1 to 10 the outer part 2 is designed to be tray-shaped. The outer part 2 has a bottom 4 and four sidewalls 5,6,7,8 that rise from the bottom 4. The respective sidewalls 5,6,7,8 join in corners 18. There are four corners 18.

The container 1 further has an inner part 3 that is made from a plastic material. In the embodiment shown in the Fig. the inner part 3 is designed to be tray-shaped. The inner part 3 has a bottom 9 and four sidewalls 10,11,12,13 that rise from a bottom 9. The respective sidewalls 10,11,12,13 join in corners 17. There are four corners 17.

The inner part 3 is arranged inside the outer part 2. The inner part 3 has a rim 14 that protrudes over outer part 2.

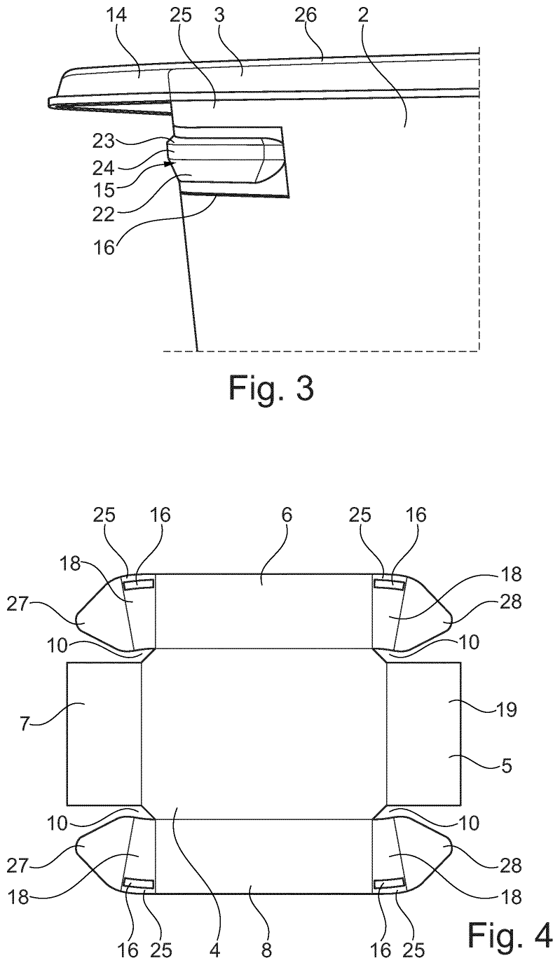

The inner part 3 has at least one protruding nose 15, whereby the nose 15 is arranged distanced from the rim 14. The outer part 2 has a window 16, whereby the nose 15 protrudes from the inside of the outer part 2 through the window 16 (see e.g. FIG. 3). The nose 15 is arranged closer to the rim 14 than to the bottom 9 of the inner part 3.

The inner part 3 has four noses 15. The respective one of the four noses 15 is arranged to protrude from a corner. The outer part 2 has four windows 16. The respective one of the four windows 16 is in a corner 18. Each nose 15 of the four noses 15 protrudes from the inside of the outer part 2 through one of the four windows 16.

The inner part 3 is a deep-drawn (thermoformed) part. The outer part 2 is made from a blank 19 of a material that contains cardboard and/or paper by way of bending and attaching individual parts of the blank 19 to other parts of the blank 19. FIG. 4 shows the blank 19 and by way of use of the reference signs 5,6,7,8 indicates those parts of the blank that will become the sidewalls of the outer part 2 and by way of references sign 18 indicates those parts of the blank that will become the corners 18 of the outer part 2. The blank has tip ends 27 that will be glued to that part of the blank that is referenced with the reference sign 7. The blank has tip ends 28 that will be glued to that part of the blank that is referenced with the reference sign 6. The free areas indicated with reference sign 20 will become the venting openings of the outer part 2.

The inner part 3 has a transition zone each between the bottom 9 and each of the four corners 17. In each of the four transition zones a step 21 is provided that protrudes into the inside of the inner part 3.

The inner part 3 is not glued to the outer part 2, but is held in the outer part 2 by way of the engagement of the noses 15 with the windows 16.

As can best be seen in FIGS. 3 and 9, the nose 15 has a first surface section 22 that is pointing away from the rim 14 and a second surface section 23 that is facing the rim 14. The first surface section 22 joins the second surface section 23 by way of forming a ridge 24 of the nose 15.

A lid (not shown in the Fig) can be attached to the rim 14. Alternatively or in addition, a foil (not shown in the Fig) that closes the inner part 3 can be attached to the rim 14 of the inner part 3.

According to the method for assembly of a container 1 the inner part 3, whereby the inner part 3 is a deep-drawn thermoformed part, and the outer part 2, whereby the outer part 2 is made from a blank 19 of a material that contains cardboard and/or paper by way of bending and attaching individual parts of the blank 19 to other parts of the blank 19, are provided (see FIG. 2). The inner part 3 is placed inside the outer part 2 in such a manner that the nose 15 protrudes from the inside of the outer part 2 through the window 16, hence forming the container 1 as shown in FIG. 1

According to the method for disassembly of a container 1 either the inner part 3 is pulled out of the outer part 2 and thereby pulling the nose 15 back inside through the window 16 or the inner part 3 is pulled out of the outer part 2, whereby the nose 15 is made to tear a strip 25 of material of the outer part 2 arranged between the window 16 and an upper edge 26 of the outer part 2.

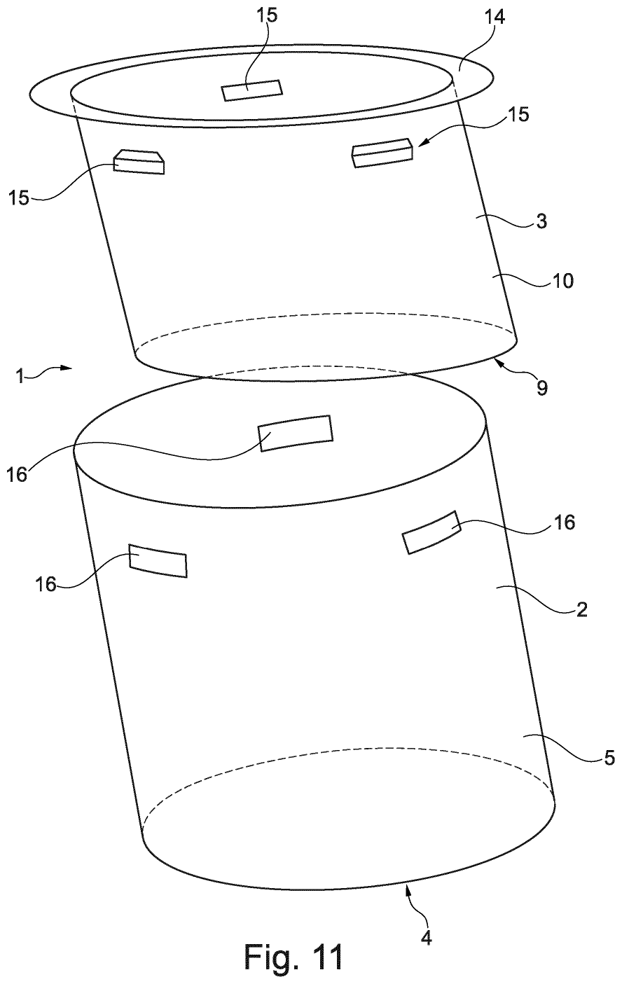

FIG. 11 shows the inner part 2 and the outer part 3 of a container 1 that is suitable for holding portioned food, for example a meat portion or a dairy product like butter or margarine. The container 1 is shown in a view similar to the tray-shaped container shown in FIG. 2, namely in a not yet assembled form. The container shown in FIG. 11 has an outer part 2 that is made from a material that contains cardboard and/or paper. In the embodiment shown in the FIG. 11 the outer part 2 is designed to be cup-shaped. The outer part 2 has a bottom 4 and one circumferential sidewall 5 that rises from the bottom 4.

The container 1 of FIG. 11 further has an inner part 3 that is made from a plastic material. In the embodiment shown in the FIG. 11 the inner part 3 is designed to be cup-shaped. The inner part 3 has a bottom 9 and one sidewall 10 that rises from a bottom 9.

The inner part 3 is arranged inside the outer part 2. The inner part 3 has a rim 14 that protrudes over outer part 2.

The inner part 3 has three noses 15. The respective one of the three noses 15 is arranged to protrude from the circumferential wall 10. The outer part 2 has three windows 16. The respective one of the four windows 16 is in the circumferential sidewall 5. Each nose 15 of the three noses 15 protrudes from the inside of the outer part 2 through one of the three windows 16.

1-14. (canceled)

15. Container suitable for holding portioned food, the container having:
an outer part that is made from a material that contains cardboard and/or paper and is tray-shaped or cup-shaped, the outer part having a bottom and either a circumferential sidewall that rises from the bottom, if the outer part is cup-shaped, or has a plurality of sidewalls that rise from the bottom, if the outer part is tray-shaped, and
an inner part that is made from a plastic material and is tray-shaped or cup-shaped, the inner part having a bottom and either a circumferential sidewall that rises from the bottom, if the inner part is cup-shaped, or has a plurality of sidewalls that rise from the bottom, if the inner part is tray-shaped,
wherein the inner part is arranged inside the outer part,
wherein the inner part has a rim that protrudes over the outer part,
wherein
the inner part has at least one protruding nose, wherein the nose is arranged distanced from the rim and
the outer part has a window, wherein the nose protrudes from the inside of the outer part through the window.

16. Container according to claim 15, wherein the nose is arranged closer to the rim than to the bottom of the inner part.

17. Container according to claim 15, wherein:
the inner part and the outer part are cup-shaped and a plurality of noses are arranged to protrude from the circumferential sidewall of the inner part, wherein the outer part has a plurality of windows arranged on the circumferential sidewall of the outer part, wherein each nose protrudes from the inside of the outer part through one of the plurality of windows,
or
the inner part and the outer part are tray-shaped, wherein the inner part has a plurality of noses, wherein the respective one of the plurality of noses is arranged to protrude either from one of the sidewalls or from a corner that is formed where two neighboring sidewalls join, wherein the outer part has a plurality of windows, wherein the respective one of the plurality of windows is in one of the sidewalls or in a corner that is formed where two neighboring sidewalls join, wherein each nose of the plurality of noses protrudes from the inside of the outer part through one of the plurality of windows.

18. Container according to claim 17, wherein:
the inner part and the outer part are tray-shaped,
wherein the inner part has a number of n sidewalls and a number of n corners, wherein the respective corner is formed where two neighboring sidewalls join,
wherein the inner part has a number of n noses, wherein at each of the n corners one nose is arranged to protrude from said corner,
wherein the outer part has a number of n sidewalls and a number of n corners, wherein the respective corner is formed where two neighboring sidewalls join,
wherein the outer part has a number of n windows, wherein at each of the n corners one window is arranged,
wherein each nose protrudes from the inside of the outer part through one of the windows.

19. Container according to claim 18, wherein the number n is either 3 or 4 or 5 or 6 or 7 or 8.

20. Container according to claim 15, wherein:
the inner part is a deep-drawn (thermoformed) part
and/or
the outer part is made from a blank of a material that contains cardboard and/or paper by way of bending and attaching individual parts of the blank to other parts of the blank.

21. Container according to claim 15, wherein the outer part has at least one venting opening arranged either in the bottom or in a part of a sidewall that is close to the bottom or in a transition zone between the bottom and a sidewall.

22. Container according to claim 15, wherein the inner part has a transition zone between the bottom and a sidewall or a transition zone between the bottom and a corner that is formed where two neighboring sidewalls join, wherein a step that protrudes into the inside of the inner part is arranged at the transition zone.

23. Container according to claim 15, wherein the inner part is not glued to the outer part.

24. Container according to claim 15, wherein the nose has
a first surface section that is pointing away from the rim and
a second surface section that is facing the rim and
wherein the first surface section joins the second surface section by way of forming a ridge of the nose.

25. Container according to claim 15, further comprising a lid attached to the rim of the inner part and/or a foil that closes the inner part attached to the rim of the inner part.

26. Method for assembly of a container, the container having:
an outer part that is made from a material that contains cardboard and/or paper and is tray-shaped or cup-shaped, the outer part having a bottom and either a circumferential sidewall that rises from the bottom, if the outer part is cup-shaped, or has a plurality of sidewalls that rise from the bottom, if the outer part is tray-shaped, and
an inner part that is made from a plastic material and is tray-shaped or cup-shaped, the inner part having a bottom and either a circumferential sidewall that rises from the bottom, if the inner part is cup-shaped, or has a plurality of sidewalls that rise from the bottom, if the inner part is tray-shaped,
wherein the inner part is arranged inside the outer part,
wherein the inner part has a rim that protrudes over the outer part,
wherein
the inner part has at least one protruding nose, wherein the nose is arranged distanced from the rim and.
the outer part has a window, wherein the nose protrudes from the inside of the outer part through the window;
the method comprising:
providing the inner part, wherein the inner part is a deep-drawn (thermoformed) part,
providing the outer part, wherein the outer part is made from a blank of a material that contains cardboard and/or paper by way of bending and attaching individual parts of the blank to other parts of the blank,
or providing a blank of a material that contains cardboard and/or paper and by way of bending and attaching individual parts of the blank to other parts of the blank can be formed into an outer part,
if the inner part and the outer part are provided, placing the inner part inside the outer part in such a manner that the nose protrudes from the inside of the outer part through the window,
if the inner part and a blank is provided,
(1) either forming the outer part by way of bending and attaching individual parts of the blank to other parts of the blank and placing the inner part inside the thus obtained outer part in such a manner that the nose protrudes from the inside of the outer part through the window,
(2) or bending and attaching individual parts of the blank to other parts of the blank in close proximity to the inner part and hence forming the outer part around the inner part with no need to perform the additional step of placing the inner part inside the outer part, but performing the steps of or bending and attaching individual parts of the blank to other parts of the blank in such a manner that the nose protrudes from the inside of the thus obtained outer part through the window.

27. Method for disassembly of a container, the container having:
an outer part that is made from a material that contains cardboard and/or paper and is tray-shaped or cup-shaped, the outer part having a bottom and either a circumferential sidewall that rises from the bottom, if the outer part is cup-shaped, or has a plurality of sidewalls that rise from the bottom, if the outer part is tray-shaped, and
an inner part that is made from a plastic material and is tray-shaped or cup-shaped, the inner part having a bottom and either a circumferential sidewall that rises from the bottom, if the inner part is cup-shaped, or has a plurality of sidewalls that rise from the bottom, if the inner part is tray-shaped,
wherein the inner part is arranged inside the outer part,
wherein the inner part has a rim that protrudes over the outer part,
wherein
the inner part has at least one protruding nose, wherein the nose is arranged distanced from the rim and
the outer part has a window, wherein the nose protrudes from the inside of the outer part through the window;
the method comprising:
pulling the inner part out of the outer part and thereby pulling the nose back inside through the window,
or
pulling the inner part out of the outer part, wherein the nose is made to tear a strip of material of the outer part arranged between the window and an upper edge of the outer part.
